(19) United States
(12) Patent Application Publication
(10) Pub. No.: US 2010/0108460 A1
(43) Pub. Date: May 6, 2010

(54) PARKING MECHANISM OF AUTOMATIC TRANSMISSION

(75) Inventors: Kazuaki Nakamura, Aichi-ken (JP); Kazuyuki Watanabe, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/527,053

(22) PCT Filed: Feb. 14, 2008
(86) PCT No.: PCT/IB08/00336

§ 371 Date: Aug. 13, 2009

(30) Foreign Application Priority Data
Feb. 16, 2007 (JP) 2007-036610

(51) Int. Cl. F16H 61/22

(52) U.S. Cl. 192/219.5

(57) ABSTRACT

A fulcrum cam (24) for moving the fulcrum of a parking lock pole 22 is configured to move the fulcrum of a parking lock pole (22) such that the widthwise center of a protrusion (22a) of the parking lock pole (22) is moved along a radial line L extending from the axis of rotation P of the parking gear (21) through the circumferential center of a corresponding notch (21b) from point X1 through point X2 to point X3.

### BACKGROUND OF THE INVENTION

1. Field of the Invention

The present invention relates to a parking mechanism of an automatic transmission.

2. Description of the Related Art

As described in Japanese Utility Model Application Publication No. 6-49849 (JP-U-6-49849), an automatic transmission is provided with a parking mechanism for locking a rotating shaft of the automatic transmission to inhibit rotation of the rotating shaft when the vehicle driver selects a parking range with a shift lever, for example.

The parking mechanism includes a parking gear that is secured to the rotating shaft, a parking lock pole for switching the parking gear between a locked state, in which the parking gear cannot rotate, and an unlocked state, in which the parking gear can rotate, and a cam for swinging the parking lock pole that is made of a generally elongated rectangular plate about a fulcrum at an end thereof.

The parking lock pole is swingably supported at one end and has a pawl that engages with notches between the teeth of the parking gear at the other end.

The parking lock pole is urged in the unlocking direction by a suitable reverse spring. The cam is disposed in contact with the other end of the parking lock pole, and the parking lock pole is moved toward or away from the parking gear by moving the cam.

The parking mechanism operates as follows. When the vehicle driver selects the parking range with the shift lever, the apex of the cam is moved to a position where it presses the parking lock pole. Then, the parking lock pole is moved toward the parking gear against the elasticity of the reverse spring until the parking lock pole is engaged with one of the notches of the parking gear to establish a locked state in which the parking gear and the rotating shaft cannot rotate.

When a range other than the parking range is selected, the apex of the cam is moved to a position where it cannot contact the parking lock pole. Then, the parking lock pole is moved away from the parking gear by the elastic restoring force of the reverse spring until the parking lock pole is disengaged from the parking gear to establish an unlocked state in which the parking gear and the rotating shaft can rotate.

A parking mechanism as described above is shown in FIG. 8. In such a parking mechanism, when the parking lock pole 22 is moved from a position indicated by broken lines to a position indicated by solid lines in FIG. 8, the widthwise center of the distal end of the pawl 22a is displaced from point X1 to point X2. That is, the movement locus R that connects the displacement points X1 and X2 is an arc having the radius of curvature r, which is the distance from the swinging fulcrum O at the one end of the parking lock pole 22 to the widthwise center of the distal end of the pawl 22a.

It is necessary to reduce the space occupied by the parking lock pole 22 for a compact design. However, when the length of the parking lock pole 22 is decreased, the radius of curvature r of the arc as the movement locus R of the pawl 22a also decreases.

When the radius of curvature r decreases, the divergence of the widthwise center of the distal end of the pawl 22a of the parking lock pole 22 from a radial line L extending from the axis of rotation P of the parking gear 21 through the circumferential center of the corresponding notch 21b and the inclination of the pawl 22a with respect to the corresponding notch 21b increase as the displacement of the pawl 22a in its width direction increases.

Then, the pawl 22a is likely to interfere with the teeth 21a of the parking gear 21 when engaging the pawl 22a of the parking lock pole 22 with one of the notches 21b of the parking gear 21 and the process of disengaging the pawl 22a from the corresponding notch 21b, and therefore the pawl 22a and the teeth 21a may be subjected to fatigue damage relatively early.

Although the pawl is tapered toward its distal end and the notches are increased in width toward their open ends in JP-U-6-49849, the possibility of the interference as described above still remains.

If the length of the parking lock pole is maximized to increase the radius of curvature of the arc as the movement locus of the pawl as much as possible, the divergence of the widthwise center of the distal end of the pawl 22a may be decreased and the interference as described above is reduced or avoided. However, this is not practical because the space occupied by the parking lock pole increases against the intention of compact design.

### SUMMARY OF THE INVENTION

The present invention provides a parking mechanism of a vehicle automatic transmission in which the interference between a pawl (protrusion) on a parking lock pole and notches of a parking gear when engaging or disengaging the pawl with the notches is reduced to improve the service life of both the pawl and the parking gear.

A first aspect of the present invention relates to a parking mechanism of an automatic transmission which includes: a parking gear, that is provided on a rotating shaft in the automatic transmission; a parking lock pole having a protrusion that removably engages with the parking gear, and switch means that moves the parking lock pole toward the parking gear until the protrusion engages the parking gear to switch the parking lock pole to a locked state and moves the parking lock pole away from the parking gear until the protrusion is disengaged from the parking gear to switch the parking lock pole to an unlocked state. The parking mechanism of an automatic transmission includes a fulcrum cam that moves the fulcrum of the parking lock pole.

In the parking mechanism of an automatic transmission, when the switch means switches the parking lock pole between the locked and unlocked states, the fulcrum cam moves the fulcrum of the parking lock pole such that the widthwise center of the protrusion of the parking lock pole moves along a radial line that extends from the axis of rotation of the parking gear to the circumferential center of a notch of the parking gear.

According to this configuration, when the parking lock pole is moved by the switch means, the widthwise center of the protrusion of the parking lock pole is displaced substantially linearly along the radial line.

Therefore, the divergence of the widthwise center of the protrusion from the radial line may be decreased, and the angle of the protrusion relative to the corresponding notch does not change significantly. As a result, the protrusion is less likely to interfere with the teeth of the parking gear in the process of engaging the protrusion of the parking lock pole with the notches of the parking gear and in the process of disengaging the protrusion from the corresponding notch, and the protrusion can be therefore engaged and disengaged from the notches of the parking gear relatively easily and smoothly. Thus, it is possible to reduce fatigue damage to the protrusion and the notches.

In the above aspect, the fulcrum cam may be received in a circular hole formed through one end of the parking lock pole in which the fulcrum cam smoothly rotates in the circular hole, have a rotating shaft at an eccentric position, and be of a circular shape as seen in a plan view.

This configuration has a defining feature that the fulcrum cam is located at the one end of the parking lock pole where it is supported and the fulcrum of the parking lock pole may be moved by rotating the rotating shaft of the fulcrum cam. With this defining feature, the structure is simplified and the occupied space may be reduced.

In the above aspect, the parking mechanism of an automatic transmission may further include detection means for detecting a shift range selected in the automatic transmission, and control means for controlling the switch means in response to the detected shift range by the detection means. When the detection means detects that a parking range is selected, the control means controls the switch means to switch the parking lock pole to the locked state.

According to this configuration, because shift operation means such as shift lever and the switch means may be connected electrically instead of mechanically, the structure of the parking mechanism can be simplified.

In the above aspect, the fulcrum cam may be provided at the one end of the parking lock pole, and the parking lock pole may be made of a generally elongated rectangular plate and have an other end which is moved toward and away from the parking gear.

This configuration has a defining feature that the fulcrum cam is provided at the one end of the parking lock pole where it is supported, and the other end of the parking lock pole is moved toward and away from the parking gear. With this defining feature, the structure may be simplified and the occupied space can be reduced.

In the above aspect, the switch means may include a switching cam that applies a biasing force to the parking lock pole in a direction toward the parking gear, and an elastic member that pulls the parking lock pole away from the parking gear may be provided. The switching cam has a convex portion, which is formed on a specific part of the outer periphery of the switching cam that applies a pressure to the parking lock pole so that the parking lock pole is moved toward the parking gear against the biasing force of the elastic member. The switching cam also has a base circular portion that is formed on a specific part of the outer periphery of the switching cam that does not apply a pressure to the parking lock pole so that the parking lock pole may be moved away from the parking gear by the biasing force of the elastic member.

In the above aspect, the switch means may allow the parking lock pole to be switched to an unlocked state by the elastic member when the detected shift range is a shift range other than the parking range. The switch means switches the parking lock pole to a locked state by the switching cam when the detected shift range is the parking range.

In the above aspect, the fulcrum cam may be moved by the switch means or may be moved by a drive means other than the switch means.

In the above aspect, the fulcrum may be located at the center of the fulcrum cam as seen in a plan view, and the fulcrum may be displaced toward the other end when the parking lock pole is switched to the locked state, and displaced toward the one end when the parking lock pole is switched to the unlocked state.

In the above aspect, the fulcrum cam may be rotated in one direction or both directions to switch the parking lock pole between the locked state and the unlocked state.

A second aspect of the present invention relates to a parking mechanism of an automatic transmission which includes: a parking gear, that is provided on a rotating shaft in the automatic transmission; a parking lock pole having a protrusion that removably engages with the parking gear, and switch means that moves the parking lock pole toward the parking gear until the protrusion engages the parking gear to switch the parking lock pole to a locked state and moves the parking lock pole away from the parking gear until the protrusion is disengaged from the parking gear to switch the parking lock pole to an unlocked state. The parking mechanism of an automatic transmission includes guide means that supports the parking lock pole such that the parking lock pole may be moved linearly toward and away from the axis of rotation of the parking gear without changing the angle with respect to the parking gear.

According to this configuration, when the parking lock pole is moved by the switch means, the widthwise center of the protrusion of the protrusion is displaced substantially linearly along the radial line.

Therefore, the divergence of the widthwise center of the protrusion of the parking lock pole from the radial line can be decreased, and the angle of the protrusion relative to the corresponding notch does not change significantly. As a result, the protrusion is less likely to interfere with the teeth of the parking gear in the process of engaging the protrusion of the parking lock pole with the notches of the parking gear and in the process of disengaging the protrusion from the corresponding notch, and the protrusion can be therefore engaged with and disengaged from the notches relatively easily and smoothly. Thus, it is possible to minimize fatigue damage to the protrusion and the notches.

In the above aspect, the parking mechanism of an automatic transmission may further include detection means for detecting a shift range selected in the automatic transmission, and control means for controlling the switch means in response to the detected shift range by the detection means. When the detection means detects that a parking range is selected, the control means controls the switch means to switch the parking lock pole to the locked state.

According to this configuration, because shift operation means such as a shift lever and the switch means may be connected electrically instead of mechanically, the structure of the parking mechanism may be simplified.

In the above aspect, the switch means may include a switching cam that applies a biasing force to the parking lock pole in a direction toward the parking gear, and an elastic member that pulls the parking lock pole away from the parking gear may be provided. Each switching cam has a convex portion formed on a specific part of the outer periphery of the switching cam that applies a pressure to the parking lock pole so that the parking lock pole can be moved toward the parking gear against the biasing force of the elastic member, and a base circular portion formed on a specific part of the outer periphery of the switching cam that does not apply a pressure to the parking lock pole so that the parking lock pole can be moved away from the parking gear 21 by the biasing force of the elastic member.

In the above aspect, the switch means may allow the parking lock pole to be switched to an unlocked state by the elastic member when the detected shift range is a shift range other than the parking range. The switch means may allow the parking lock pole to be switched to a locked state by the switching cam when t detected he shift range is the parking range.

In the above aspect, the guide means may include a guide pin and a guide hole for guiding the parking lock pole to slide in parallel to the axis of rotation of the parking gear.

In the above aspect, the guide pin may have a larger dimension in the sliding direction of the parking gear.

In the above aspect, the parking lock pole may be supported generally perpendicular to a line extending from the axis of rotation of the parking gear to the longitudinal center of the parking lock pole, the switching cam may be disposed in contact with the longitudinal center of the parking lock pole, and the elastic member is provided at each end of the parking lock pole.

In the above aspect, the parking lock pole may be supported generally perpendicular to a line extending from the axis of rotation of the parking gear to the longitudinal center of the parking lock pole, the switching cam may be disposed in contact with each end of the parking lock pole, and the elastic member may be provided at the longitudinal center of the parking lock pole.

In the above aspect, the parking lock pole may be supported generally along a line extending from the axis of rotation of the parking gear to the longitudinal center of the parking lock pole, the switching cam may be disposed in contact with an end of the parking lock pole opposite the parking gear, and the elastic member may be provided on transverse opposite sides of the parking lock pole at a longitudinal intermediate portion of the parking lock pole.

According to the above aspects, interference between the protrusion of the parking lock pole and notches of the parking gear when engaging or disengaging the protrusion with the notches of the parking gear may be minimized without increasing the occupied space. Therefore, because fatigue damage to the protrusion and the notches is minimized, the service life of the parking gear, the parking lock pole and so on is improved.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic view of an automatic transmission to which a parking mechanism according to the present invention is applied.

FIG. 2 is a perspective view illustrating the parking mechanism shown in FIG. 1.

FIG. 3 is a front view of the parking mechanism shown in FIG. 2, which is in an unlocked state.

FIG. 4 is a front view of the parking mechanism shown in FIG. 2, which is in a locked state.

FIG. 5 is a side view of the parking mechanism shown in FIG. 3, which is in an unlocked state.

FIG. 6 is a side view of the parking mechanism shown in FIG. 4, which is in a locked state.

FIG. 7 is a view illustrating the operation of the parking mechanism according to the present invention.

FIG. 8 is a view illustrating the operation of a related art parking mechanism.

FIG. 9, which corresponds to FIG. 3, shows a second embodiment of the parking mechanism according to the present invention.

FIG. 10, which corresponds to FIG. 4, shows the parking mechanism shown in FIG. 9.

FIG. 11 is a view illustrating the operation of the parking mechanism shown in FIG. 9.

FIG. 12, which corresponds to FIG. 11, shows another embodiment of the parking mechanism according to a first modification of the second embodiment of the present invention.

FIG. 13, which corresponds to FIG. 11, shows another embodiment of the parking mechanism according to a second modification of the second embodiment of the present invention.

### DETAILED DESCRIPTION OF THE EMBODIMENTS

Embodiments of the present invention are described below with reference to

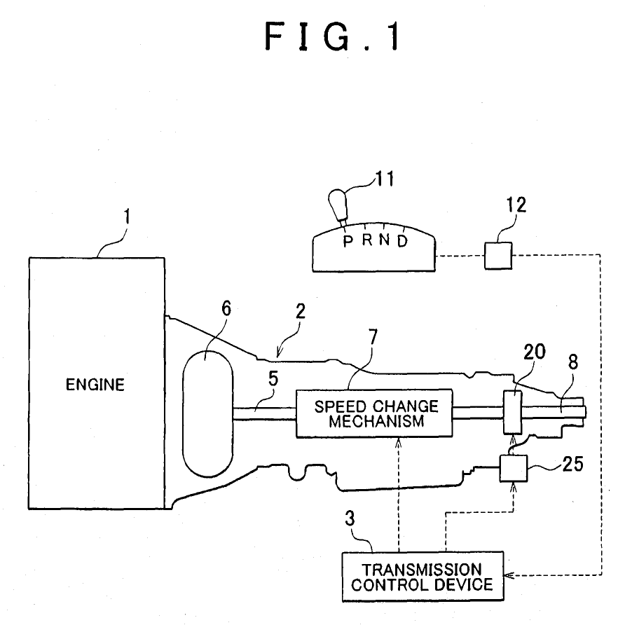

FIG. 1 through FIG. 13

### First Embodiment

Referring to FIG. 1, an outline of one example of an automatic transmission to which a parking mechanism of the present invention is applicable is described.

FIG. 1 shows an engine 1, and an automatic transmission 2. In this embodiment, the automatic transmission 2 is mounted in a front engine-rear drive (FR) vehicle.

In the FR vehicle, the automatic transmission 2 changes the speed of the rotational driving force generated by the engine 1 and transmits the driving force to the right and left rear wheels via a propeller shaft and a differential (which are not shown).

The automatic transmission 2 essentially includes an input shaft 5, a torque converter 6, a speed change mechanism 7, an output shaft 8, and other components.

The automatic transmission 2 operates as follows. When the rotation of the crankshaft (not shown) of the engine 1 is transmitted to the input shaft 5 via the torque converter 6, the rotational driving force is converted at a desired gear ratio by the speed change mechanism 7 and output from the output shaft 8.

Although not specifically shown, the speed change mechanism 7 may be constituted of a multi-speed planetary mechanism, a gear mechanism having a plurality of gears, or a continuously variable mechanism.

The speed change operation of the automatic transmission 2 is controlled by a transmission control device 3. The transmission control device 3 may be a generally known Electronic Control Unit (ECU).

When a shift lever 11 which is located, for example in the vicinity of the driver's seat of the vehicle, is operated by the driver to select a desired range (parking range, reverse range, neutral range, drive range etc.), the selected range is detected by a shift position sensor 12. Based on the detected range position, the transmission control device 3 controls a hydraulic control device via a given drive system (not shown) to establish the desired gear drive.

The shift position sensor 12 is an embodiment of the detection means of the present invention, and the transmission control device 3 is an embodiment of the control means of the present invention.

The automatic transmission 2 is provided with a parking mechanism 20.

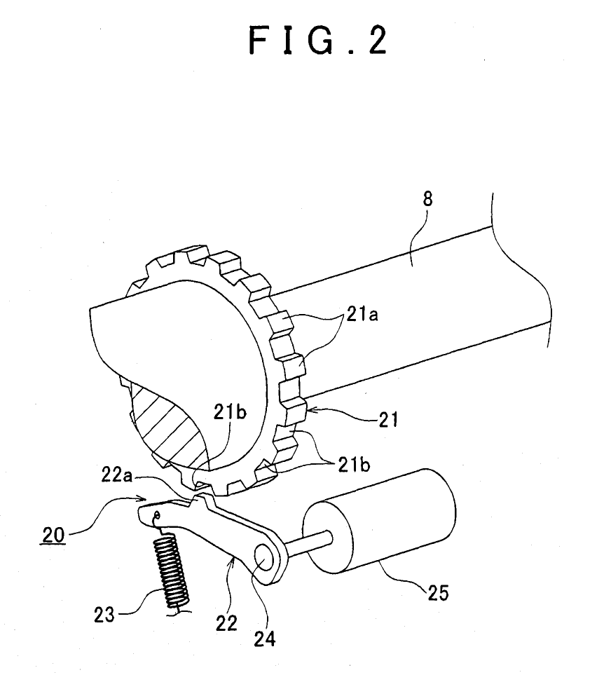

The parking mechanism 20 inhibits rotation of the output shaft 8 of the automatic transmission 2 when the parking range is selected, for example by the driver, and essentially includes a parking gear 21, a parking lock pole 22, a reverse spring 23, a switching cam (not shown), a fulcrum cam 24, and an electric actuator 25, as shown in FIG. 2 to FIG. 6. The arrangement and shapes of these components are suitably selected and not limited to those described in this embodiment.

The parking gear 21 is fixed to the exterior of the output shaft 8, and has teeth 21a on its outer periphery.

The parking lock pole 22 is made of a generally elongated rectangular plate and is supported at one end in a cantilever fashion so that the other end may be displaced toward and away from the parking gear 21. At the other end of the parking lock pole 22a pawl 22a is formed that removably engages with notches 21b between the teeth 21a of the parking gear 21.

The pawl 22a is tapered toward its distal end, and the notches 21b gradually increase in width toward their open ends. The pawl 22a may serve as the protrusion of the present invention.

The reverse spring 23 biases the parking lock pole 22 in a direction away from the parking gear 21, and may be any type of spring such as coil spring or plate spring.

The switching cam switches the parking lock pole 22 between an unlocked state, in which the parking gear 21 and the output shaft 8 are allowed to rotate, and a locked state, in which rotation of the parking gear 21 and the output shaft 8 are prohibited. The mechanism for switching the parking lock pole 22 between the unlocked and locked state is not limited to a cam. For example, a piston that is driven by hydraulic pressure or a structure in which the parking lock pole 22 is directly driven by the shift lever 11 may be employed.

The switching cam may serve as the switch means of the present invention.

The fulcrum cam 24, which moves the fulcrum of the parking lock pole 22, is of a circular shape and has a rotating shaft 24a at a position offset from its center.

The fulcrum cam 24 is slidably received in a circular hole 22b formed through the one end of the parking lock pole 22 in the thickness direction. To enable the fulcrum cam 24 to be slidably received in the hole 22b, at least one of the outer peripheral surface of the fulcrum cam 24 and the inner peripheral surface of and the hole 22b may be coated with a suitable lubricating film or that at least one of the fulcrum cam 24 and the parking lock pole 22 be made of a material having lubricity. The fulcrum cam 24 and the rotating shaft 24a may be formed integrally with each other or formed separately and joined together.

The electric actuator 25 is a motor that rotates the fulcrum cam 24. The electric actuator 25 has an output shaft, which may be connected directly to the rotating shaft 24a of the fulcrum cam 24 or connected to the fulcrum cam 24 via a suitable reducer mechanism (worm gear or the like).

An actuator serving as a power source for driving the switching cam may be provided in addition to the electric actuator 25 for rotating the fulcrum cam 24, or the electric actuator 25 may be used to drive both the switching cam and the fulcrum cam 24. For example, the switching cam and the rotating shaft of the fulcrum cam 24 may be operatively connected by a gear or chain.

The fulcrum cam 24 is an embodiment of the fulcrum cam of the present invention.

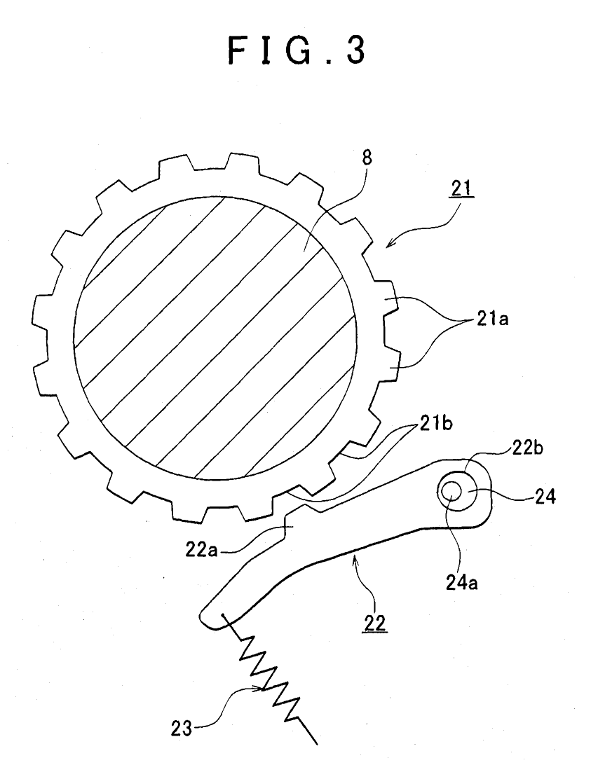

Referring now to FIG. 3 to FIG. 7, the operation of the parking mechanism 20 is described below.

When the parking range is selected, the shift position sensor 12 detects the range position and outputs a signal that indicates the detected range position to the transmission control device 3.

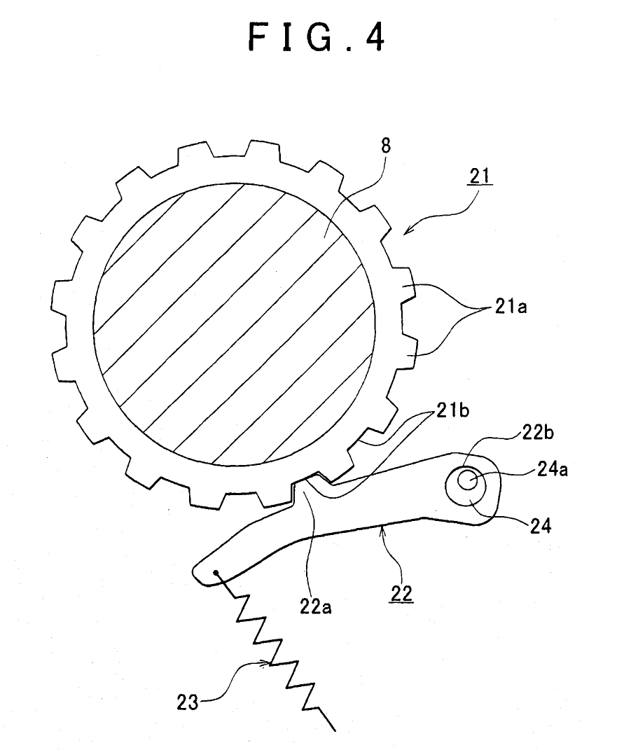

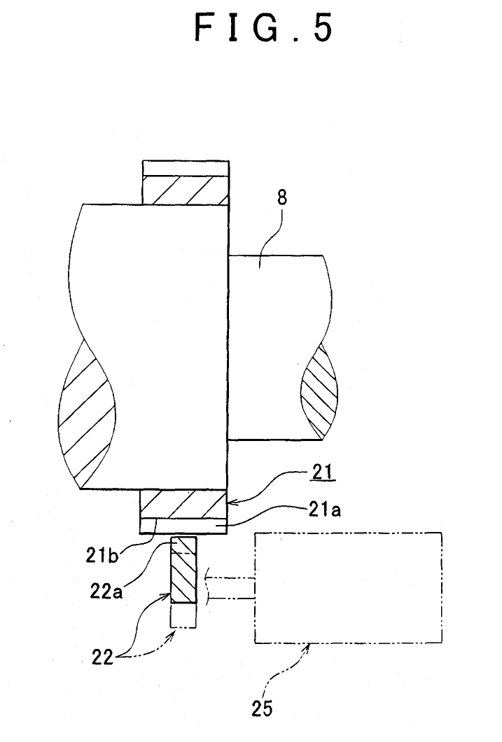

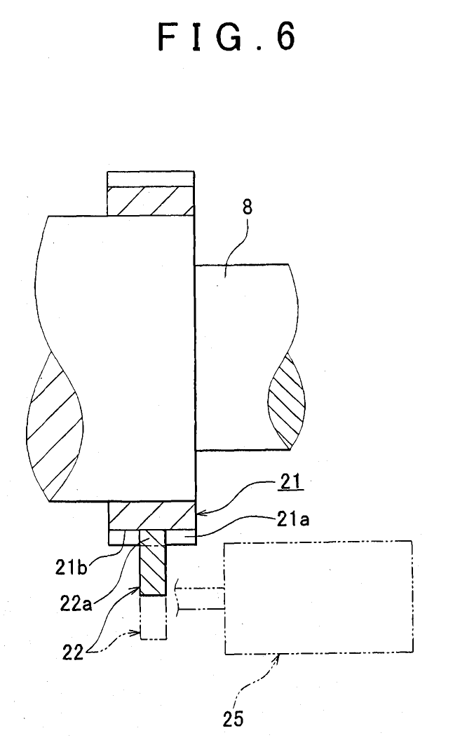

The transmission control device 3 controls the switching cam such that the parking lock pole 22 in the unlocked state as shown in FIG. 3 and FIG. 5 is moved toward the parking gear 21 until the pawl 22a engages one of the notches 21b of the parking gear 21 as shown in FIG. 4 and FIG. 6 to bring the parking lock pole 22 into the locked state to inhibit rotation of the parking gear 21 and the output shaft 8.

At this time, the transmission control device 3 simultaneously controls the electric actuator 25 to rotate the fulcrum cam 24 in the clockwise direction, so that the fulcrum of the parking lock pole 22 is moved from the position shown in FIG. 3 to the position shown in FIG. 4. That is, the fulcrum is moved, as shown in FIG. 3 and FIG. 4, generally to the lower left (from its rightmost position to its lowermost position) as shown in the drawings.

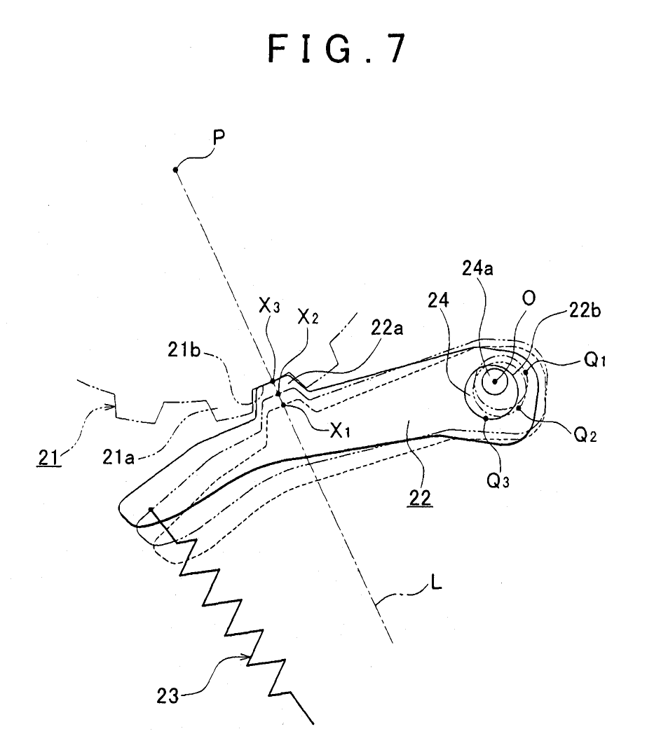

Referring to FIG. 7, the movement of the parking lock pole 22 is described in detail.

Because the reverse spring 23 pulls the other end of the parking lock pole 22 away from the parking gear 21, when the fulcrum cam 24 rotates about the central axis O of the rotating shaft 24a, the fulcrum cam 24 slides in the hole 22b of the parking lock pole 22.

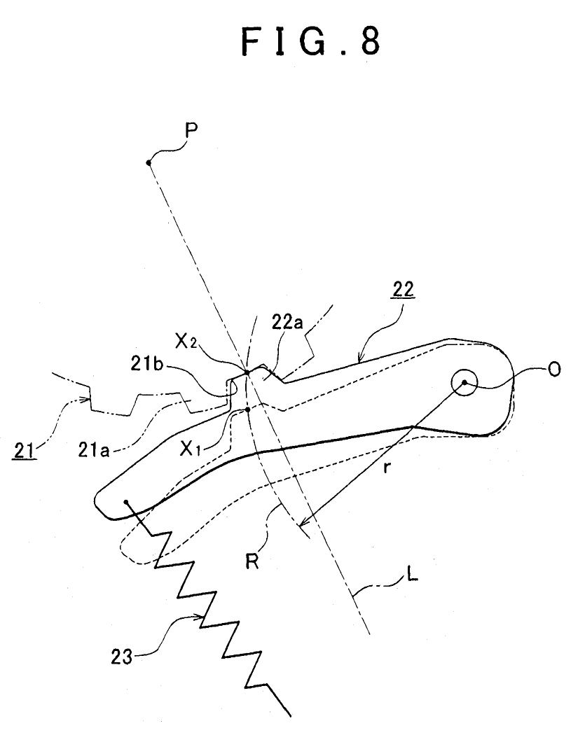

Thus, the apex of the fulcrum cam 24 (the point on the outer peripheral surface of the cam farthest away from the rotating shaft 24a is defined as the apex) is displaced from point Q1 through point Q2 to point Q3 as shown in FIG. 7. Because of the displacement of the apex of the fulcrum cam 24, the parking lock pole 22 does not take a rotary motion as in the related art shown in FIG. 8 but is gradually moved toward the parking gear 21 from the position shown by broken lines in FIG. 7 through the position shown by double-dot dash lines in FIG. 7 to the position shown by solid lines in FIG. 7.

Because of the movement of the parking lock pole 22, the widthwise center of the distal end of the pawl 22a is displaced substantially linearly along a radial line L extending from the axis of rotation P of the parking gear 21 through the circumferential center of a corresponding one of the notches 21b from point X1 through point X2 to point X3 as shown in FIG. 7. In other words, the widthwise center of the distal end of the pawl 22a is displaced generally linearly toward the axis of rotation P of the parking gear 21.

Therefore, the divergence of the widthwise center of the distal end of the pawl 22a from the radial line L is decreased, and the angle of the pawl 22a relative to the corresponding notch 21b does not change significantly. As a result, the pawl 22a of the parking lock pole 22 is less likely to interfere with the teeth 21a of the parking gear 21, and the pawl 22a may be engaged with the corresponding notch 21b relatively easily and smoothly.

When a range other than the parking range is selected, the shift position sensor 12 detects the range position and outputs a signal that indicates the detected range position to the transmission control device 3. Then, in contrast to the above, the electric actuator 25 rotates the rotating shaft 24a of the fulcrum cam 24 in the counterclockwise direction as shown in FIG. 4.

When the fulcrum cam 24 is rotated in the counterclockwise direction, the fulcrum of the parking lock pole 22 is moved from the position shown in FIG. 4 to the position shown in FIG. 3. That is, the fulcrum of the parking lock pole is moved generally to the upper right (from its lowermost position to its rightmost position) as shown in the drawings.

At this time, the transmission control device 3 simultaneously controls the switching cam. Therefore, because the pressure of the switching cam on the parking lock pole 22 is gradually decreased, the parking lock pole 22 is pulled away from the parking gear 21 by the restoring force of the reverse spring 23 until the pawl 22a is disengaged from the corresponding notch 21b of the parking gear 21. As a result, the parking lock pole 22 is brought into the unlocked state.

Referring now to FIG. 7, the movement of the parking lock pole 22 is described in detail.

The apex of the fulcrum cam 24 (the point on the outer peripheral surface of the cam farthest away from the rotating shaft 24a is defined as the apex) is displaced from point Q3 through point Q2 to point Q1 as shown in FIG. 7. Because of the displacement of the apex of the fulcrum cam 24, the parking lock pole 22 does not take a rotary motion as in the related art shown in FIG. 8 but is gradually moved toward the parking gear 21 from the position shown by solid lines in FIG. 7 through the position shown by double-dot dash lines in FIG. 7 to the position shown by broken lines in FIG. 7.

Because the pawl 22a is also displaced generally linearly along the radial line L in the unlocking process, the pawl 22a is less likely to interfere with the teeth 21a of the parking gear 21, and the pawl 22a can be disengaged from the notch 21b relatively easily and smoothly.

As described above, the parking mechanism 20 of this embodiment is configured such that, when the parking mechanism 20 is brought into the locked state or the unlocked state, the widthwise center of the distal end of the pawl 22a of the parking lock pole 22 is displaced generally linearly along the radial line L extending from the axis of rotation P of the parking gear 21 through the circumferential center of a corresponding one of the notches 21b.

Therefore, the divergence of the widthwise center of the distal end of the pawl 22a of the parking lock pole 22 from the radial line L can be decreased, and the angle of the pawl 22a relative to the corresponding notch 21b does not change significantly. As a result, the pawl 22a is less likely to interfere with the teeth 21 a of the parking gear 21 when engaging the pawl 22a of the parking lock pole 22 with the corresponding notch 21b of the parking gear 21 and in the process of disengaging the pawl 22a from the corresponding notch 21b, and the pawl 22a can be therefore engaged with and disengaged from the notches 21b relatively easily and smoothly.

Thus, with the above parking mechanism, it is possible to minimize fatigue damage to the pawl 22a and the notches 21b and improve the service life of the parking gear 21, the parking lock pole 22 and so on.

In addition, because the angle of the pawl 22a is not changed significantly in the process of displacing the pawl 22a toward or away from the notches 21b as described above, even if the shift lever 11 is accidentally shifted into the parking range while the vehicle is running, ratcheting, a situation where the pawl 22a of the parking lock pole 22 is repelled by the teeth of the parking gear 21, occurs and the parking lock pole 22 is displaced away from the parking gear 21, the pawl 22a is less likely to be caught in any of the notches 21b of the rotating parking gear 21. As a result, damage to the pawl 22a and the notches 21b may be minimized.

### First Modification of the First Embodiment

The basic configuration of the automatic transmission 2 to which this embodiment is applicable is not limited to that of an automatic transmission of the type mounted in an FR vehicle as described above, and is applicable to other configurations such as that of an automatic transmission mounted in an FF vehicle.

Although the parking gear 21 of the parking mechanism 20 is mounted on the output shaft 8 thereof in the automatic transmission 2 for an FR vehicle as described in the above embodiment, the parking gear 21 may be provided on the counter driven gear, for example, in the case of an automatic transmission for an FF vehicle. In this case, the output shaft 8 and the counter driven gear may correspond to the rotating shaft of the present invention.

### Second Modification of the First Embodiment

Although a configuration using the fulcrum cam 24 and the electric actuator 25 is used as the means for moving the fulcrum of the parking lock pole 22 in the first embodiment, a mechanical power transmission mechanism having a shift cable (not shown) extending from the shift lever 11 may be used to rotate the fulcrum cam 24 of the parking lock pole 22 instead of the electric actuator 25. Such a mechanical power transmission mechanism is well known and hence its description is omitted here.

When the shift lever 11 and the parking lock pole 22 are operatively connected by a shift cable (not shown), the pawl 22a is less likely to interfere with the teeth 21a of the parking gear 21 in the locking and unlocking processes as described above, and the pawl 22a may be engaged and disengaged from the notches 21b relatively easily and smoothly. In addition to the effect, the force necessary to shift the shift lever 11 may be reduced.

### Third Modification of the First Embodiment

Although the electric actuator 25 is controlled such that the electric actuator 25 rotates the fulcrum cam 24 in the clockwise direction to move the apex of the fulcrum cam 24 from its rightmost position to its lowermost position, as shown in FIG. 7, when the parking lock pole 22 is switched from the unlocked state to the locked state in the first embodiment, what is necessary is that the widthwise center of the distal end of the pawl 22a of the parking lock pole 22 is displaced lineally along the radial line L extending from the axis of rotation P of the parking gear 21 through the circumferential center of one of the notches 21b by moving the fulcrum of the parking lock pole 22.

The fulcrum cam 24 may be rotated in the clockwise direction by the electric actuator 25 to displace the apex of the fulcrum cam 24 shown in FIG. 7 from its rightmost position to its leftmost position, and from its lowermost position to its left most position, for example. Also, the fulcrum cam 24 may be rotated in the counterclockwise direction to displace the apex of the fulcrum cam 24 shown in FIG. 7 from its rightmost position to its uppermost position, from its rightmost position to the leftmost position, and from its uppermost position to its leftmost position, for example.

### Fourth Modification of the First Embodiment

Although the fulcrum cam 24 is rotated in the clockwise direction when the parking lock pole 22 is switched from the unlocked state to the locked state and the fulcrum cam 24 is rotated in the counterclockwise direction when the parking lock pole 22 is switched from the locked state to the unlocked state in the first embodiment, control may be provided such that the fulcrum cam 24 is rotated only in one direction. That is, what is necessary is that the fulcrum of the parking lock pole 22 is moved to the left as shown in FIG. 3, FIG. 4 and so on when the parking lock pole 22 is switched from the unlocked state to the locked state, and the fulcrum of the parking lock pole 22 is moved to the right as shown in FIG. 3, FIG. 4 and so on when the parking lock pole 22 is switched from the locked state to the unlocked state.

### Second Embodiment

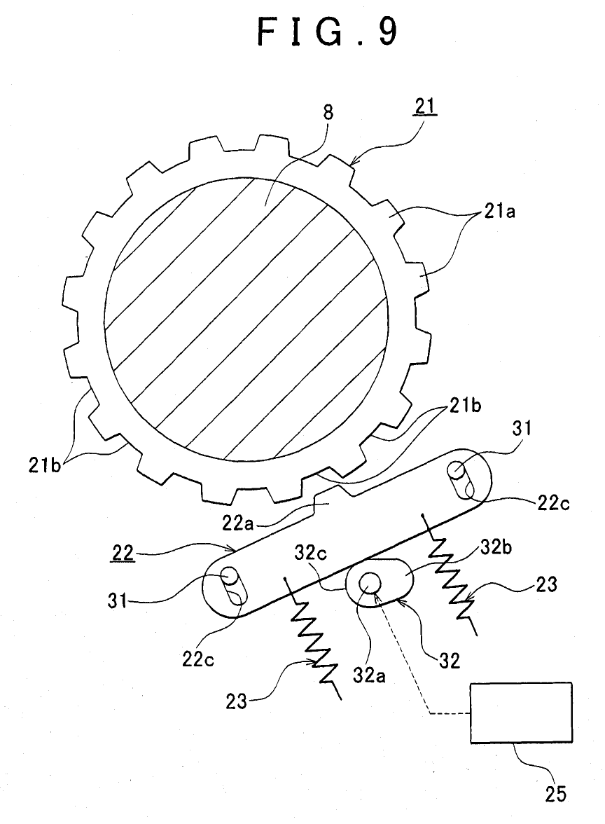

A second embodiment of the present invention is described with reference to FIG. 9 to FIG. 11. The same components as those of the first embodiment are designated by the same reference numerals and their description is not repeated. The differences from the first embodiment are primarily described below.

As shown in FIG. 9, the parking mechanism has a parking lock pole 22 with slots 22c, extending in the transverse direction of the parking lock pole 22, formed at each end, guide pins 31 formed on a case or the like of the automatic transmission 2 and received in the slots 22c, a switching cam 32 disposed in contact with the longitudinal center of the lower side of the parking lock pole 22, and two reverse springs 23, which serve as elastic members, provided at each end of the parking lock pole 22 that pull the parking lock pole 22 away from the parking gear 21. The guide pins 31 and the slots 22c may correspond to the guide means of the present invention. The arrangement and shapes of these components are suitably selected and not limited to this embodiment. As examples, modifications 1 and 2 are described later.

The switching cam 32 has a rotating shaft 32a, a convex portion 32b which is formed on a specific part of the outer periphery thereof and applies a pressure to the parking lock pole 22 to move the parking lock pole 22 toward the parking gear 21 against the biasing force of the reverse springs 23, and a base circular portion 32c which is formed on a specific part of the outer periphery thereof and does not apply a pressure to the parking lock pole 22 so that the parking lock pole 22 can be moved away from the parking gear 21 by the biasing force of the reverse springs 23.

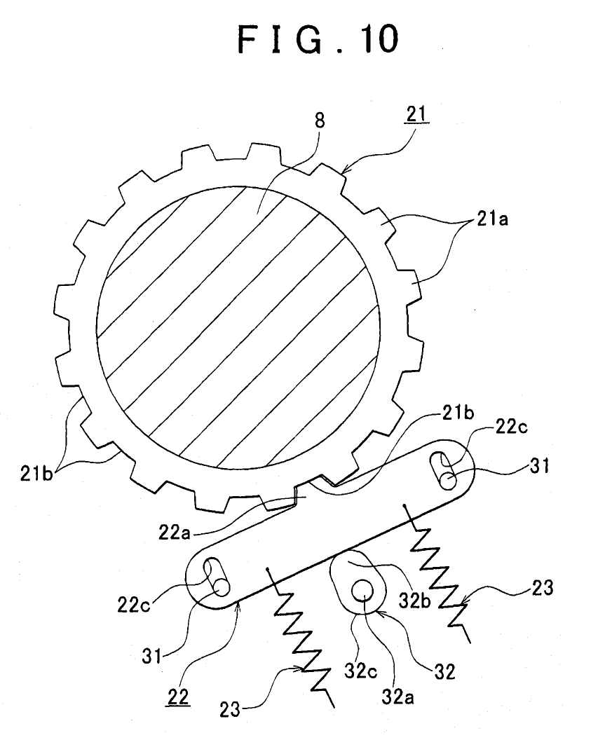

When the transmission control device 3 controls the rotation of the rotating shaft 32a of the switching cam 32 in the state shown in FIG. 9, the convex portion 32b of the switching cam 32 displaces the parking lock pole 22 toward the parking gear 21 against the biasing force of the reverse springs 23 until the pawl 22a engages one of the notches 21b of the parking gear 21, as shown in FIG. 10, to bring the parking lock pole 22 into the locked state.

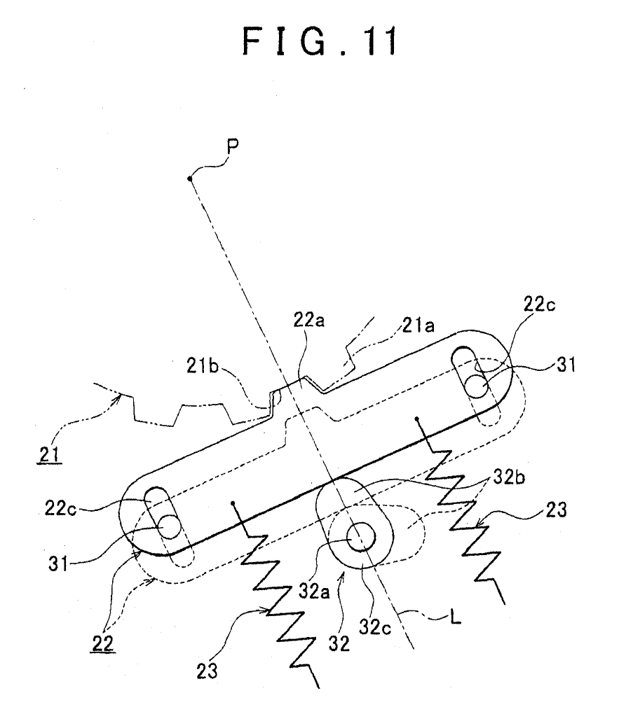

Because each end of the parking pawl 22 is supported by the slots 22c and the guide pins 31, the parking pawl 22 is displaced linearly along a radial line L that extends from the rotational axis P of the parking gear 21 through the circumferential center of the corresponding notch 21b without changing its angle, as shown in FIG. 11. Thus, the pawl 22a of the parking lock pole 22 does not interfere with the teeth 21a of the parking gear 21, and the pawl 22a may engage the corresponding notch 21b relatively easily and smoothly.

The parking lock pole 22 is also displaced linearly without changing its angle when unlocking the transmission. Thus, the pawl 22a of the parking lock pole 22 does not interfere with the teeth 21a of the parking gear 21, and the pawl 22a is disengaged from the notch 21b relatively easily and smoothly.

Thus, according to this embodiment, it is possible to reduce fatigue damage to the pawl 22a and the notches 21b and improve the service life of the parking gear 21, the parking lock pole 22 and so on.

### First Modification of the Second Embodiment

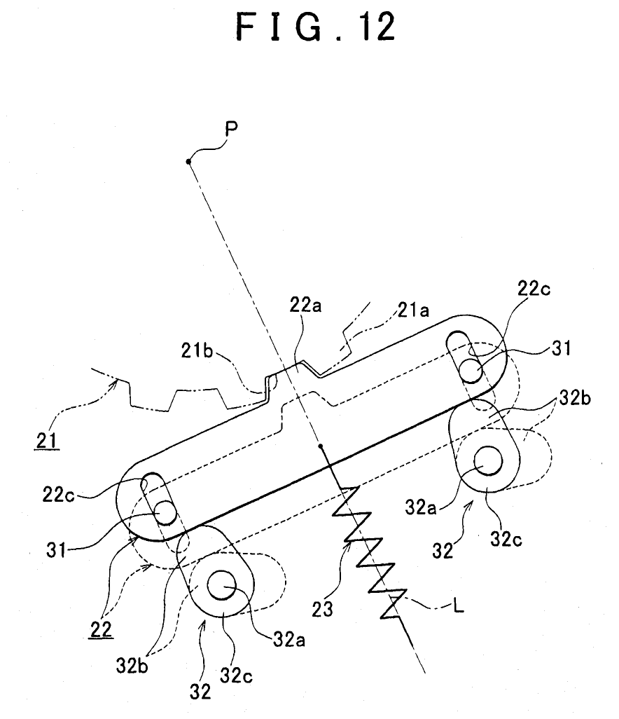

Although one switching cam 32 contacts the longitudinal center of the lower side of the parking lock pole 22, and two reverse springs 23 are provided at longitudinal opposite ends of the parking lock pole 22 in the above second embodiment, one reverse spring 23 may be provided at the longitudinal center of the parking lock pole 22 and two switching cams 32 may be disposed in contact with the longitudinal opposite ends of the lower side of the parking lock pole 22 as shown in FIG. 12.

### Second Modification of the Second Embodiment

Although the parking lock pole 22 is moved in its width direction in the second embodiment, the parking lock pole 22 and associated members may be so arranged that the parking lock pole 22 can be moved in its longitudinal direction.

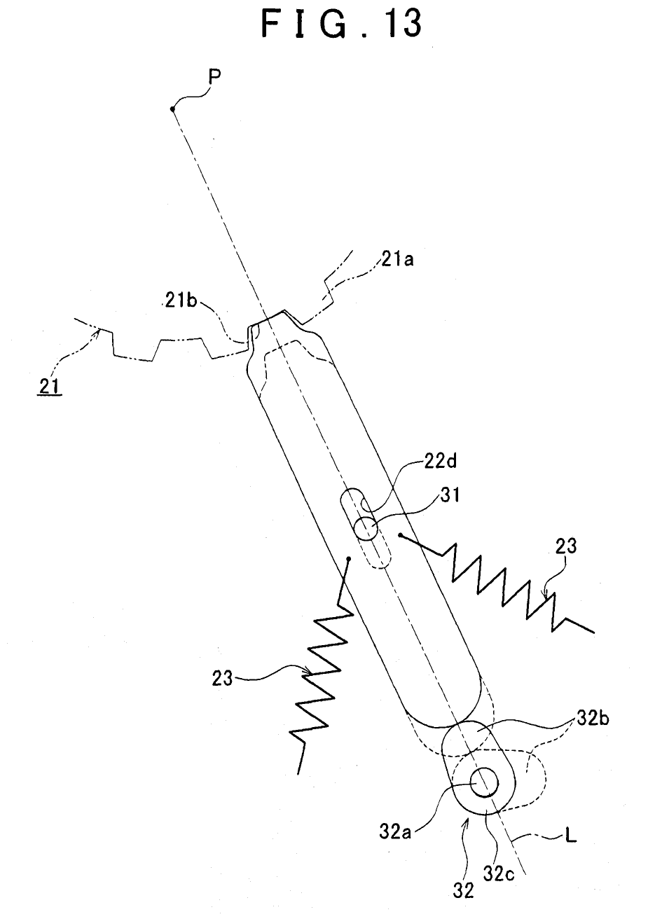

As shown in FIG. 13, the parking mechanism has a parking lock pole 22 arranged at an angle of 90° from the position shown in FIG. 9 and has a slot 22d extending in its longitudinal direction at its longitudinal center, a guide pin 31 formed on the case of the automatic transmission 2 or the like and received in the slot 22d, a switching cam 32 disposed in contact with the longitudinal lower end of the parking lock pole 22, and two reverse springs 23 provided on transverse opposite side of the parking lock pole 22 at a longitudinal intermediate portion of the parking lock pole 22 that pull the parking lock pole 22 away from the parking gear 21. The slot 22d and the guide pin 31 may be provided at any position. Furthermore, a slot 22d and the associated guide pin 31 may be provided at each end of the parking pawl 22.

### Third Modification of the Second Embodiment

In the above second embodiment and the modifications thereof, the diameter of the guide pin or pins 31 may have a larger dimension in the sliding direction of the parking lock pole 22 than in the other directions. With this configuration, the parking lock pole 22 may be linearly moved toward and away from the parking gear more reliably.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations other combinations and configurations, including more, less or only a single element, are also within the spirit and scope of the invention.

1. A parking mechanism of an automatic transmission comprising:
a parking gear, that is provided on a rotating shaft in the automatic transmission;
a parking lock pole having a protrusion that removably engages with the parking gear;
switch portion that moves the parking lock pole toward the parking gear until the protrusion engages the parking gear to switch the parking lock pole to a locked state and moves the parking lock pole away from the parking gear until the protrusion is disengaged from the parking gear to switch the parking lock pole to an unlocked state; and
a fulcrum cam that moves the fulcrum of the parking lock pole;
wherein, when the switch portion switches the parking lock pole between the lock and unlocked states, the fulcrum cam moves the fulcrum of the parking lock pole such that the widthwise center of the protrusion of the parking lock pole moves along a radial line that extends from the axis of rotation of the parking gear to the circumferential center of a notch of the parking gear,
wherein the fulcrum cam is provided at the one end of the parking lock pole, and the parking lock pole is made of a generally elongated rectangular plate and has an other end that is moved toward and away from the parking gear.

2. The parking mechanism of an automatic transmission according to claim 1,
wherein the fulcrum cam is received in a circular hole formed through one end of the parking lock pole in which the fulcrum cam smoothly rotates, has a rotating shaft at an eccentric position, and is of a circular shape as seen in a plan view.

3. The parking mechanism of an automatic transmission according to claim 1,
further comprising detection portion for detecting a shift range selected in the automatic transmission, and
control portion for controlling the switch portion in response to the detected shift range by the detection portion,
wherein, when the detection portion detects that a parking range is selected, the control portion controls the switch portion to switch the parking lock pole to the locked state.

4. (canceled)

5. The parking mechanism of an automatic transmission according claim 1,
wherein the switch portion includes a switching cam that applies a biasing force to the parking lock pole in a direction toward the parking gear, and
an elastic member for pullingly urging the parking lock pole in a direction away from the parking gear is provided, and the switching cam has a convex portion, formed on a specific part of the outer periphery of the switching cam, that applies a pressure to the parking lock pole so that the parking lock pole is moved toward the parking gear against the biasing force of the elastic member, and a base circular portion, formed on a specific part of the outer periphery of the switching cam, that does not apply a pressure to the parking lock pole so that the parking lock pole can be moved away from the parking gear by the biasing force of the elastic member.

6. The parking mechanism of an automatic transmission according to claim 5,
wherein the switch portion allows the parking lock pole to be switched to an unlocked state by the elastic member when the detected shift range is a shift range other than a parking range.

7. The parking mechanism of an automatic transmission according to claim 5,
wherein the switch portion allows the parking lock pole to be switched to a locked state by the switching cam when the detected shift range is a parking range.

8. The parking mechanism of an automatic transmission according to claim 1, wherein the fulcrum cam is moved by the switch portion.

9. The parking mechanism of an automatic transmission according claim 1, wherein the fulcrum cam is moved by a drive portion other than the switch portion.

10. The parking mechanism of an automatic transmission according to claim 2, wherein the fulcrum is located at the center of the fulcrum cam as seen in a plan view, and the fulcrum is displaced toward the other end when the parking lock pole is switched to the locked state and displaced toward the one end when the parking lock pole is switched to the unlocked state.

11. The parking mechanism of an automatic transmission according to claim 1, wherein the fulcrum cam is rotated in one direction or both directions to switch the parking lock pole between the locked state and the unlocked state.

12. A parking mechanism of an automatic transmission comprising:
a parking gear, that is provided on a rotating shaft in the automatic transmission;
a parking lock pole having a protrusion that removably engages with the parking gear;
switch portion that moves the parking lock pole toward the parking gear until the protrusion engages the parking gear to switch the parking lock pole to a locked state and moves the parking lock pole away from the parking gear until the protrusion disengages the parking gear to switch the parking lock pole to an unlocked state; and
guide portion for supporting the parking lock pole such that the parking lock pole is moved linearly toward and away from the axis of rotation of the parking gear without changing the angle with respect to the parking gear,
wherein the guide portion includes a guide pin and a guide hole for guiding the parking lock pole to perform translational movement along the axis of rotation of the parking gear.

13. The parking mechanism of an automatic transmission according to claim 12, further comprising:
detection portion for detecting a shift range selected in the automatic transmission, and
control portion for controlling the switch portion in response to the detected shift range by the detection portion,
wherein, when the detection portion detects that a parking range is selected, the control portion controls the switch portion to switch the parking lock pole to the locked state.

14. The parking mechanism of an automatic transmission according to claim 12, wherein the switch portion includes a switching cam that applies a biasing force to the parking lock pole in a direction toward the parking gear, and
an elastic member that pulls the parking lock pole away from the parking gear is provided, and
each switching cam has a convex portion, formed on a specific part of the outer periphery of the switching cam, that applies a pressure to the parking lock pole so that the parking lock pole is moved toward the parking gear against the biasing force of the elastic member, and a base circular portion, formed on a specific part of the outer periphery of the switching cam, that does not apply a pressure to the parking lock pole so that the parking lock pole is moved away from the parking gear by the biasing force of the elastic member.

15. The parking mechanism of an automatic transmission according to claim 14, wherein the switch portion allows the parking lock pole to be switched to an unlocked state by the elastic member when the detected shift range is a shift range other than a parking range.

16. The parking mechanism of an automatic transmission according to claim 14, wherein the switch portion allows the parking lock pole to be switched to a locked state by the switching cam when the detected shift range is a parking range.

17. (canceled)

18. The parking mechanism of an automatic transmission according to claim 12, wherein the guide pin has a larger dimension in the sliding direction of the parking lock pole.

19. The parking mechanism of an automatic transmission according to claim 14, wherein the parking lock pole is supported generally perpendicular to a line extending from the axis of rotation of the parking gear to the longitudinal center of the parking lock pole,
the switching cam is disposed in contact with the longitudinal center of the parking lock pole, and
the elastic member is provided at each end of the parking lock pole.

20. The parking mechanism of an automatic transmission according to claim 14, wherein the parking lock pole is supported generally perpendicular to a line extending from the axis of rotation of the parking gear to the longitudinal center of the parking lock pole,
the switching cam is disposed in contact with each end of the parking lock pole, and
the elastic member is provided at the longitudinal center of the parking lock pole.

21. The parking mechanism of an automatic transmission according to claim 14,
wherein the parking lock pole is supported generally along a line extending from the axis of rotation of the parking gear to the longitudinal center of the parking lock pole,
the switching cam is disposed in contact with an end of the parking lock pole opposite the parking gear, and
the elastic member is provided on transverse opposite sides of the parking lock pole at a longitudinal intermediate portion of the parking lock pole.
